(19) United States
(12) Patent Application Publication
(10) Pub. No.: US 2013/0205767 A1
(43) Pub. Date: Aug. 15, 2013

(54) APPARATUS FOR CONSERVING WATER IN A HYDRO POWER PLANT

(71) Applicant: Sunil Gajanan Shinde, Maharashtra (IN)

(72) Inventor: Sunil Gajanan Shinde, Maharashtra (IN)

(21) Appl. No.: 13/825,861

(22) PCT Filed: Sep. 26, 2011
(86) PCT No.: PCT/IN2011/000666

§ 371 Date: Mar. 25, 2013

(30) Foreign Application Priority Data
Sep. 24, 2010 (IN) 2651/MUM/2010

(51) Int. Cl. F03B 3/00

(52) U.S. Cl. CPC F03B 3/00
USPC 60/495

(57) ABSTRACT

An apparatus for conserving water in a hydro-power plant comprising a plurality of inlet channels having a one-way inlet valve corresponding to respective turbine outlets, each inlet channel directly leading to a waste valve fitted on said channel and a respective bypass line disposed adjacent said waste valve having a one-way outlet valve, said bypass line leading to an outlet disposed substantially above the level of the turbine inlet.

### FIELD OF THE INVENTION

This invention relates to the field of pumps.

### BACKGROUND

Hydropower plants produce about 24 percent of the world's electricity. Hydropower plants harness energy from water and use simple mechanics to convert that energy into electricity. Hydropower plants are actually based on a simple concept of water flowing through a dam which turns a turbine which in turn drives a generator for generating power.

A flow diagram of a conventional hydro power plant is illustrated in FIG. 1. Most hydropower plants rely on dams for holding water. This water held in a dam acts like a reservoir for water. When a control gate at an intake of the reservoir is opened, gravity pulls the water through a penstock to a turbine. As water flows through the penstock, pressure is built up. The water flowing at increased pressure strikes and turns the blades of a turbine which is a prime mover for a generator coupled to it. The generator generates electrical power which is then stepped up using a transformer and then transmitted via power lines. The water used to turn the blades of the turbine eventually flows via an outflow to a river downstream.

It is seen that a large amount of water under pressure simply flows to a river thereby wasting a lot of energy.

There is thus felt a need for an apparatus that can conserve water flowing downstream and thus increase the efficiency of the hydro power plant.

### OBJECTS OF THE INVENTION

An object of the invention is to provide an apparatus for conserving water in a hydro power plant.

Another object of the invention is to provide a simple apparatus for conserving water in a hydro power plant.

Yet another object of the invention is to provide a cost effective hydro power plant.

Still another object of the invention is to provide an apparatus that is easy to install and maintain, for conserving water in a hydro power plant.

One more object of the invention is to provide an apparatus for conserving water in a hydro power plant that is powered by hydro power.

Another object of the invention is to provide an efficient hydro power plant.

### SUMMARY OF THE INVENTION

An apparatus for conserving water in a hydro-power plant, said apparatus comprises: a plurality of inlet channels having a one-way inlet valve corresponding to respective turbine outlets, each inlet channel directly leading to a waste valve fitted on said channel and a respective bypass line disposed adjacent said waste valve having a one-way outlet valve, said bypass line leading to an outlet disposed substantially above the level of the turbine inlet.

Typically, the inlet channel comprises a substantially larger diameter than the bypass channel.

Typically, the inlet channel comprises a substantially curvilinear profile leading to said waste valve.

Typically, the waste valve comprises a flange intermittently closing the waste valve outlet in a sealing manner by means of the high energy water causing a water hammer effect thereon.

### BRIEF DESCRIPTION OF ACCOMPANYING DRAWINGS

The invention will now be described with the help of accompanying drawings, in which:

FIG. 1 illustrates a flow diagram of a conventional hydro power plant; and

FIG. 2 illustrates a flow diagram of hydro power plant in accordance with the present invention.

### DETAILED DESCRIPTION

The invention will now be described with reference to the embodiment shown in the accompanying drawings. The embodiment does not limit the scope and ambit of the invention. The description relates purely to the exemplary preferred embodiment of the invention and its suggested applications.

The diagram and the description hereto are merely illustrative and only exemplify the invention and in no way limit the scope thereof.

Hydro power plants known in the art typically involve water eventually flowing down to a river once it serves the purpose of turning the blades of a turbine for generating power. A lot of water is thus wasted.

In accordance with the present invention, an apparatus is envisaged that overcomes this drawback of the prior art and recycles at least a significant portion of the water back to the reservoir.

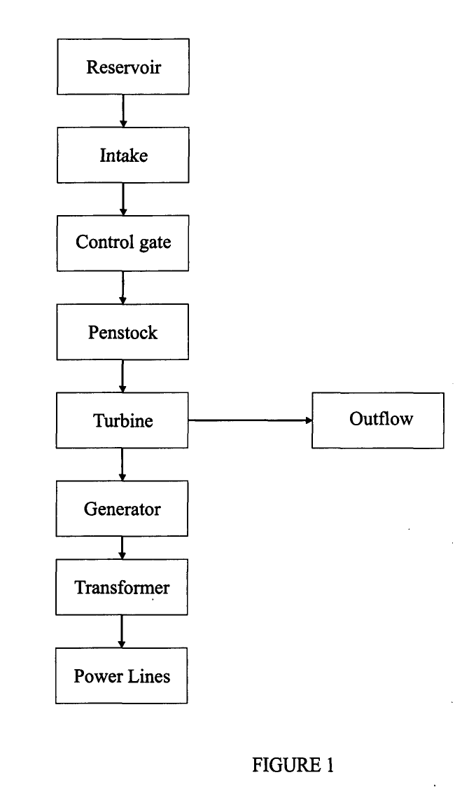

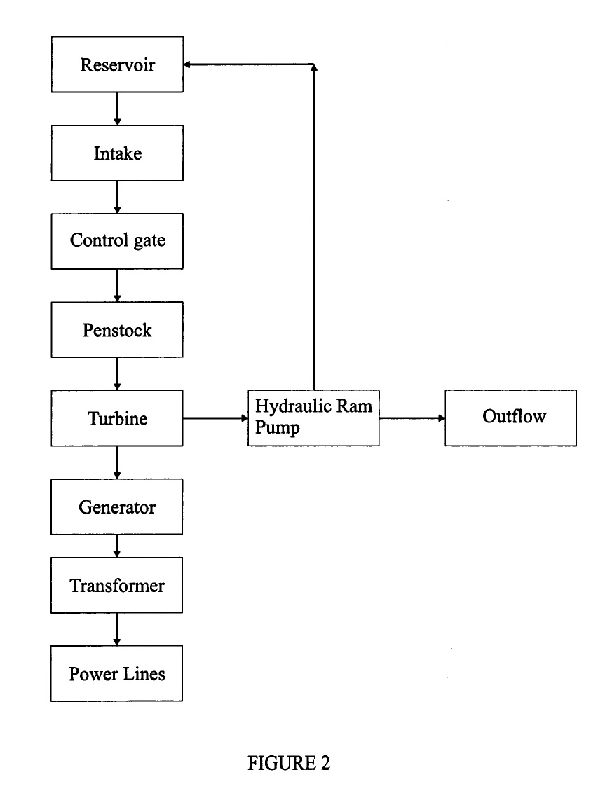

A conventional hydro power plant has been described herein above with reference to FIG. 1 wherein a flow diagram of the conventional system is illustrated. The present invention is described herein below with reference to FIG. 2 which illustrates a flow diagram of a hydro power plant as envisaged in accordance with the present invention.

Water stored in a dam which serves as a reservoir for the water has stored energy or potential energy. When a control gate at an intake of the reservoir opens, the water flowing through a penstock causes the stored energy to be converted to kinetic energy because of its motion. The kinetic energy of the flowing water turns the blades of a turbine which in turn is connected to a generator. The generator generates electrical power which is then stepped up to a high voltage by a transformer and then transmitted for use via power lines. The amount of electricity that is generated is determined by several factors. Two of those factors are the volume of water flow and the amount of hydraulic head.

The head refers to the distance between the water surface and a turbine. As the head and flow increase, so does the electricity generated. The head is usually dependent upon the amount of water in the reservoir. Thus it is evident that an increase in the amount of water stored in the reservoir will increase the efficiency of the hydro power plant.

After the water strikes the turbine and serves its purpose of turning the blades of the turbine, it is typically directed to a river downstream via an outflow, thus wasting a lot of water. In accordance with the present invention, an apparatus is envisaged to conserve this water getting wasted which could be used to increase the efficiency of the hydro power plant. The apparatus as envisaged is typically a hydraulic ram pump or a hydram that operates on hydro power and does not require any other source of power other than the kinetic energy of flowing water. This apparatus is connected in the pipeline called a tailrace that is further connected to an outflow of the hydro power plant and functions as a hydraulic transformer that takes in water at one ‘hydraulic head’ (pressure) and flow-rate, and outputs water at a higher hydraulic-head and lower flow-rate. The apparatus utilizes the water hammer effect to develop pressure that allows a portion of the input water that powers the pump to be lifted to a point higher than where the water originally started.

The apparatus as envisaged uses the downhill water pressure to pump a significant portion of that water higher uphill to the reservoir. Thus the apparatus recycles typically about 30-70% of the water flowing through the tailrace back to the reservoir to increase the amount of water stored therein and thus improve the efficiency of the hydro power plant. The amount of water that ultimately flows via the outflow downstream varies based on need. The apparatus as envisaged is complete by itself and designed to work with minimum manual intervention and is operable under all operating conditions.

### TECHNICAL ADVANCEMENTS

The technical advancements offered by the present invention include the realization of:
an apparatus for conserving water in a hydro power plant;
a simple apparatus for conserving water in a hydro power plant;
a cost effective hydro power plant;
an apparatus that is easy to install and maintain, for conserving water in a hydro power plant; and
an apparatus for conserving water in a hydro power plant that is powered by hydro power.

The numerical values given of various physical parameters, dimensions and quantities are only approximate values and it is envisaged that the values higher or lower than the numerical value assigned to the physical parameters, dimensions and quantities fall within the scope of the invention unless there is a statement in the specification to the contrary.

While considerable emphasis has been placed herein on the particular features of this invention, it will be appreciated that various modifications can be made, and that many changes can be made in the preferred embodiment without departing from the principles of the invention. These and other modifications in the nature of the invention or the preferred embodiments will be apparent to those skilled in the art from the disclosure herein, whereby it is to be distinctly understood that the foregoing descriptive matter is to be interpreted merely as illustrative of the invention and not as a limitation.

1. An apparatus for conserving water in a hydro-power plant, said apparatus comprises: a plurality of inlet channels having a one-way inlet valve corresponding to respective turbine outlets, each inlet channel directly leading to a waste valve fitted on said channel and a respective bypass line disposed adjacent said waste valve having a one-way outlet valve, said bypass line leading to an outlet disposed substantially above the level of the turbine inlet.

2. Apparatus as claimed in claim 1, wherein said inlet channel comprises a substantially larger diameter than the bypass channel.

3. Apparatus as claimed in claim 1, wherein said inlet channel comprises a substantially curvilinear profile leading to said waste valve.

4. Apparatus as claimed in claim 1, wherein said waste valve comprises a flange intermittently closing the waste valve outlet in a sealing manner by means of the high energy water causing a water hammer effect thereon.
